(19) United States
(12) Patent Application Publication
(10) Pub. No.: US 2008/0158249 A1
(43) Pub. Date: Jul. 3, 2008

(54) Method for Displaying Graphic Objects and Communications Device

(76) Inventor: Alexander Jarczyk, Freising (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/592,903

(22) PCT Filed: Mar. 10, 2005
(86) PCT No.: PCT/EP2005/051095

§ 371 Date: Sep. 14, 2006

(30) Foreign Application Priority Data
Mar. 16, 2004 (DE) 102004012896.0

(51) Int. Cl. G09G 5/00

(52) U.S. Cl. 345/619

(57) ABSTRACT

The invention relates to a method for displaying graphic objects in which the graphic objects are arranged in a virtual surface field, in particular an electronic map, the virtual surface field is larger than a display field, a section of the virtual surface field together with the graphic objects is displayed in the display field, the virtual surface field and the display field are displaced relative to one another, a threshold area is defined centrally within the display field, and graphic objects which are situated inside the display field and outside the threshold area are projected away from the centre of the display field onto the edge of the display field.

The invention relates to a method for displaying graphics objects and to a communication appliance, particularly a mobile telephone or a computer.

The constantly advancing development in the field of mobile telephones is resulting in constant miniaturization of these mobile telephones, on the one hand, and in constantly improved graphics capabilities of these mobile telephones, on the other. This prompts the users of such mobile telephones to want to make efficient use of the graphics capabilities of the mobile telephones despite the limited available surface area of the display device.

To this end, it is known practice to arrange graphics objects, such as symbols indicating a function or a program, on a virtual interface panel, for example on an electronically stored and graphically displayable map, which is larger than an available display panel. By moving the display panel over the virtual interface panel, the portion of the virtual interface panel which is displayed on the display panel can be varied and selected by the user, so that the user is able to use a marker, for example, to select all graphics objects displayed on the virtual interface panel.

It has been found to be a drawback of this solution that a user is only ever able to see part of the virtual interface panel. The user is therefore only able to imagine the presence and position of the graphics objects which are not currently displayed on the display panel but which are arranged on the virtual interface panel.

In the next few years, mobile appliances will increasingly be equipped with location based functionality. Besides this, there is already today enormous potential for using map material on mobile appliances. Even in map displays on car navigation appliances, PCs or laptops, however, positions on these maps, which have been or are created for the purpose of a journey, for example, usually end up being so diversely separate that the user usually needs to select a plurality of views in succession in order to retain the spatial overview. What is actually lacking here is the seamless transition from a spatial(ly detailed) view via summarized intermediate stations to one or more destination positions without the user losing the spatial and logical overview in the process.

Browsing maps or desktop interfaces using a limited detail (peephole) suffers from the problem that additional information, such as restaurant opening times, underground train departure times, pictures of buildings etc., cannot be examined by the user until he has clicked on the appropriate icon on the map in order to open its detailed view. That is to say that the map view (with the icons) is separate from the detailed information for the respective icons.

The invention is now based on the object of specifying a technical disclosure which allows convenient clear display of graphics objects which are arranged on a virtual interface panel which is larger than an available display panel.

This object is achieved by the features of the independent claims. Advantageous and expedient developments can be found in the dependent claims. Developments of the apparatus claim which correspond to the dependent method claims are likewise covered by the invention.

Preferably, graphics objects which are arranged on a virtual interface panel which is larger than an available display panel are thus projected onto the edge of the display panel if they are outside of a prescribed threshold region.

The effect achieved by this is that a small available display panel can be used to display a large number of graphics objects clearly and there is also still space to display additional information.

Within the context of this application, graphics objects are also understood to mean symbols, symbol parts, icons, icon parts, display windows, display window parts, pictures, picture details or texts and text elements.

The display panel is preferably formed by a display device, such as a graphics display, or part of a display device. In particular, a display panel can be produced by a graphics window.

The virtual interface panel, such as an electronic graphically displayable map, is preferably formed by information which describes the positions of graphics objects relative to a reference point on the virtual display panel, said information being stored in a memory device. In addition to this, this information can also describe the graphics objects themselves or a display scale. This or other information is also able to determine what detail of the virtual interface panel currently needs to be displayed in what display size on the display panel. The display size or the display scale of the virtual interface panel and of the graphics objects arranged thereon can be changed by the user, for example, so that the case may also arise that the display of the virtual interface panel becomes smaller than the display panel. In this case, projected display of graphics objects can be dispensed with.

The virtual interface panel is preferably larger than a display panel if the current length and/or width dimensions of the display panel are smaller than the current length and/or width dimensions of the virtual interface panel, with the display scale which currently applies to this being used to calculate the dimensions of the virtual interface panel.

Depending on the embodiment variant, a graphics object is preferably situated within a threshold region when it is situated fully or partly within the threshold region or when its center is situated within the threshold region.

The projection onto the edge of the display panel particularly covers the case in which the graphics object is moved fully or partly from its actual position on the virtual interface panel in the direction of the center of the displayed detail from the virtual interface panel and is displayed fully or partly in the edge region of the display panel. In this context, the edge region needs to be of broad design, in particular.

Preferably, graphics objects displayed by projection are displayed in reduced size in comparison with the display scale which currently applies to the virtual interface panel, are displayed in distorted form and/or are displayed as simple geometrical shapes, such as lines.

The edge regions occupied by the projected graphics objects have a minimal space requirement in the case of line display, and even when scaled semicircle projections or “half” object projections are used for display the space requirement is very small. The result is an undistorted user interface detail in the display panel which only needs a minimal additional space (in the extreme case, it is just one pixel line of the edge region) in order to be able to provide a visual display of all graphics objects and their spatial relationship with one another.

Preferably, the size of the display of a projected graphics object is set on the basis of the distance between the displayed detail from the virtual interface panel and the position of the graphics object. The reference point which is used for calculating the distance and which represents the detail displayed is preferably formed by the center of the detail displayed or of the display panel, a corner point of the detail displayed or of the display panel, the point at which an appropriate projection line intersects the edge region of the display panel or another point in the detail displayed.

The present invention preferably uses input by a two-dimensional input device, such as a pin, a mouse or the like, to move a map (virtual interface panel) relative to its peephole (display panel) first of all. In this case, all information icons (graphics objects) on the map, when they end up in the peephole, are kept projected from the center of the peephole at the edge (and connected to a reference line/arrow) until the icon enters a threshold region (particular radius measured from the center), for example. In this case, it is now firstly moved toward the center, for example, such that when the icon position is covered by the center the information area likewise adopts the central position, and secondly the surface area of the information area adopts the largest possible surface area on the basis of particular heuristics. This results in the user being able to use a single positioning interaction to make decisions about complex view conditions.

Particularly preferred refinements of the invention make the following provisions:
A) Arrangement of the information icons/areas at the inner edge of the peephole:
   As long as the referenced map position has not entered the threshold region close to the center,
      1. the information is displayed with minimal detail (by way of example, this may be the actual icon or else may actually be a small amount of additional information),
      2. is projected at the inner edge away from the center, and
      3. is possibly connected to a (red) reference line relating to the actual map position.
B) Arrangement and size of the information icons/areas in the threshold region:
   If the user moves the map relative to the peephole, so that the referenced positions enter the threshold region, then the response described in 4a changes as follows:
   1. Change in position
      The positions do not continue to be kept projected at the edge but rather are moved toward the center as the distance from the center is increasingly shortened. The direction of projection is maintained in this context. In the current prototypical implementation (code can be provided when required), this is a linear function, but it can likewise be implemented in nonlinear fashion. That is to say that if the information position is put exactly onto the center as the map moves, the information area position is likewise situated at the central position. The impression which the user then obtains upon movement in, through and out is a kind of three-dimensional magnifying glass effect for the position of the information area in question. This is particularly impressive when some information positions are close to one another and are grouped around the center.
   2. Change in size
      When the position of the information area changes as described in 4b1, there is additionally (if desired) a change in the size of said area. This change in size in the implemented prototype is at a maximum but independent of the surrounding neighboring areas where the positions of the information area and the information position overlie each other in the center. Other heuristics within the context of space division are conceivable in this case:
      a) Maximum size independently of the area neighbors has just been described and can be viewed dynamically in the prototype.
      b) Size in the threshold region “democratically” complies with the neighboring areas.
         The algorithm for this is as follows:
            Firstly, all areas determine what they would need as a maximum area and with what neighbors an area conflict would arise.
            Each area is then reduced by a certain percentage together with its conflicting neighbor so that the areas no longer overlap.
      c) Size in the threshold region “undemocratically” complies with the neighboring areas.
         The algorithm for this is as follows:
            Firstly, all areas determine what they would need as a maximum area and with what neighbors an area conflict would arise.
            All areas, whose positions are within the maximum area of the area which is closest to the center, force this area which is closest to the center to reduce its size such that at least the icons (that is to say the information areas reduced to the maximum extent) next to it have space.
            The process then continues as in 4b2b, or else:
            Each area which is closest to the center (and the ones which are even further away) undergoes the same process as the one just described (which is closest to the center).
      d) Size in the threshold region is based on other heuristics.
         Besides the algorithms just described, there are also other algorithms conceivable which introduce into the heuristics the “weight of information”, regarding in what size which area needs to be drawn in the event of conflict.
C) Information content of the information areas
   On the basis of the size described above, the information areas can be assigned degrees of detail for their information visualization. By way of example, underground stations could thus have the following
      1. Discrete levels of detail:
         a) Icon
            Only advice of the fact that more information can be found here is displayed
         b) Low
            Number of underground trains per hour
         c) Medium
            List of all underground trains which stop here
         d) Detail 1
            Additionally the departure times
         e) Detail 2
            Additionally bus/tram services These discrete details are displayed on the basis of the adjusted size.
            Similarly, pictures may have the following
      2. Continuous levels of detail, for example:
         Pictures are continually adjusted in size to the respective size of the information area. In this case, the picture itself may even represent the information area.

The invention is described in more detail below using preferred exemplary embodiments which are explained with reference to the figures listed below:

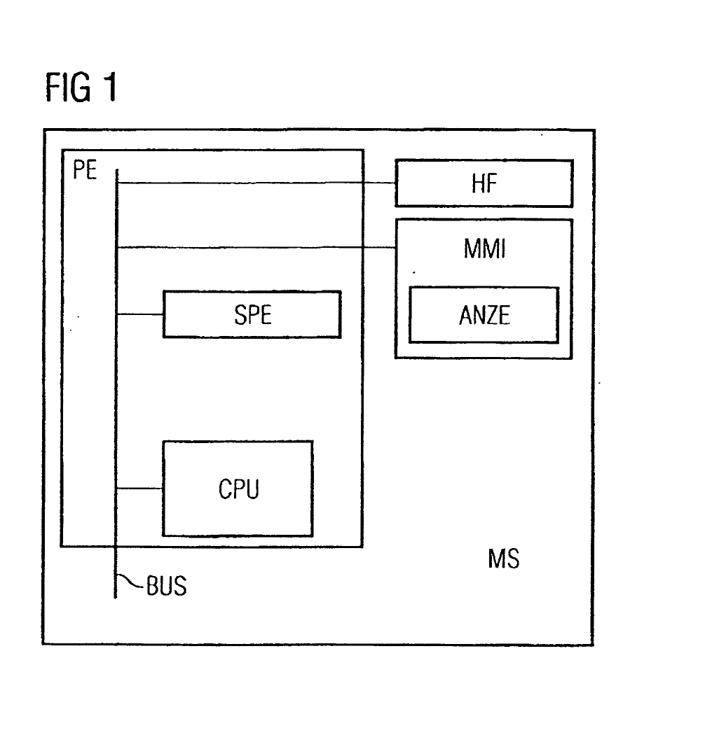

FIG. 1 block diagram of a mobile telephone;

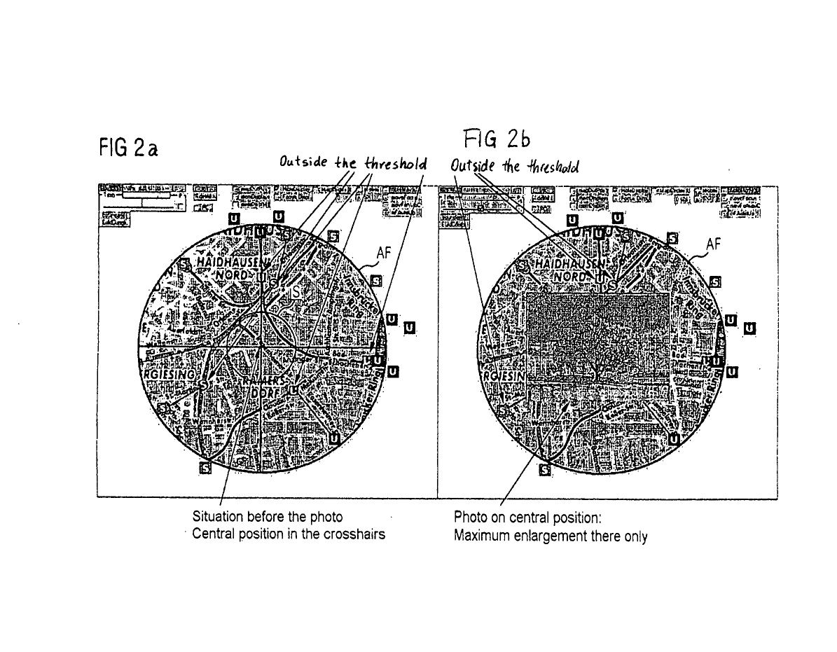

FIG. 2 first exemplary embodiment of the display and projection of graphics objects;

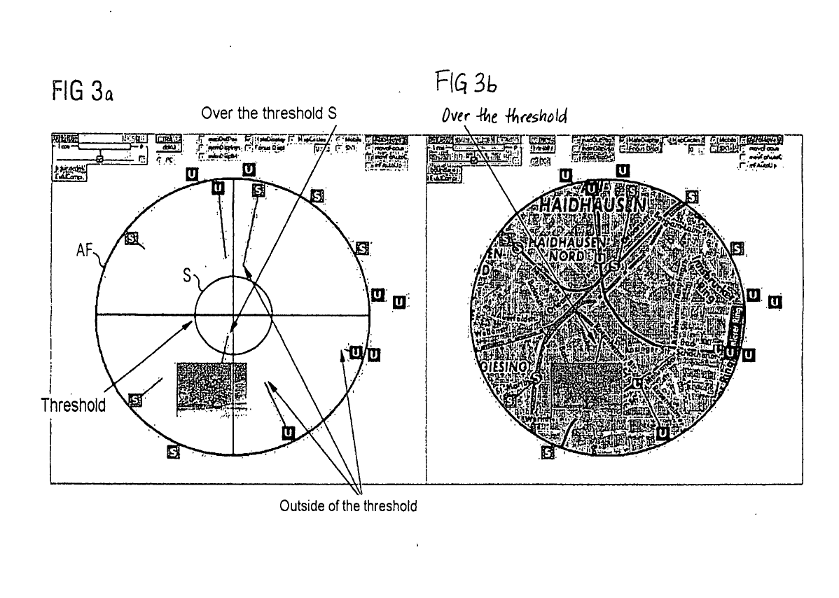

FIG. 3 second exemplary embodiment of the display and projection of graphics objects;

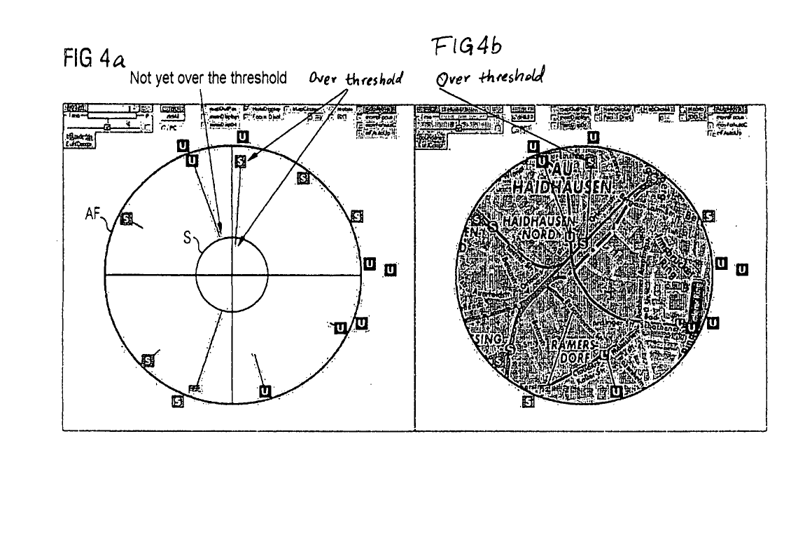

FIG. 4 third exemplary embodiment of the display and projection of graphics objects; and

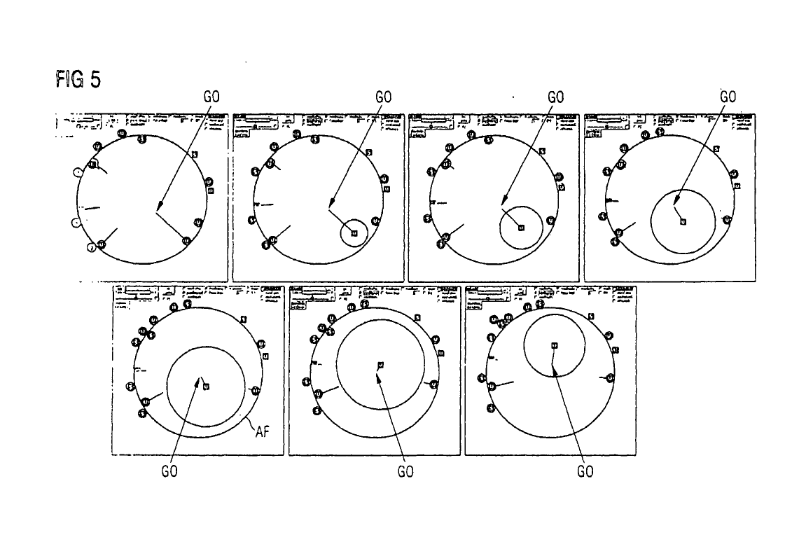

FIG. 5 fourth exemplary embodiment of the display and projection of graphics objects.

FIG. 1 shows a mobile telephone MS which contains an operator control device MMI, a radio frequency device HF and a processor device PE. The operator control device MMI comprises a display device ANZE, such as a graphics display, and operating elements, such as keys or softkeys.

To control the mobile telephone MS, the operator control unit MMI in the mobile telephone MS and the processes which are executed on the mobile telephone, a program-controlled processor device PE such as a microcontroller is provided which can also comprise a processor CPU and a memory device SPE.

Depending on the embodiment variant, further components—associated with the processor device, belonging to the processor device, controlled by the processor device or controlling the processor device—such as a digital signal processor or further memory devices may be arranged within or outside of the processor device PE in this context, the basic function of said components in connection with a processor device for controlling a mobile telephone being sufficiently well known to a person skilled in the art and therefore not being discussed in more detail at this juncture. The various components can use a bus system BUS or input/output interfaces and possibly suitable controllers to interchange data with the processor CPU.

The memory device SPE stores the program data, such as the control commands or control procedures etc., which are used for controlling the mobile telephone and the operator control unit MMI, and information regarding the description of the virtual interface panel together with graphics objects.

FIG. 2 shows the projection of graphics objects, such as underground stations U and tram stations S, which are situated outside of the threshold region SCH, onto the edge of the display panel AF.

FIG. 3 shows the projection of graphics objects, such as for a media event, which in this case is in the form of a photograph associated with a location, which are situated within the threshold region SCH, into the surface area of the display panel AF, for example in accordance with an intercept theorem. In this case, by way of example, the distance between the center of the display panel and the position of the graphics object and the distance between the center of the display panel and the boundary of the threshold region SCH have the same ratio to one another as the distance between the center of the display panel and the position of the projected graphics object and the distance between the center of the display panel and the boundary or the edge of the display panel.

FIG. 4 shows the projection of graphics objects, such as an underground station U, which is situated outside of the threshold region SCH, onto the edge of the display panel AF. In addition, the projection of a tram station shown within the threshold region SCH in accordance with the set of beams explained above is explained.

FIG. 5 shows the movement of a graphics object GO together with the projected graphics object (in this case an underground station) together with additional information (shown as a circle around the underground station) into the threshold region, within it and out of it.

The present invention can be used for the following applications, in particular:
1. Rapid browsing of a picture database which has received the information for the location (at which the picture was taken) from location based services or direct GPS position finders.
2. Rapid browsing of a sound database which has received the information for the location (at which the sound was recorded) from location based services or direct GPS position finders, and where the sound has been recorded by the user, e.g. using a dictaphone functionality of the mobile device at that location.
3. Convenient display of local and trunk routes, particularly when transfer locations are further away than the current close view would allow.
4. Journey planning which allows time and space dependent alarms to be prepared which are then triggered during the actual journey by location based and/or GPS based services.
5. Holiday browsing through all kinds of “memories” which can be displayed using multimedia.
6. Journey information system.
7. Tourist information system.

1-5. (canceled)

6. A method for displaying graphics objects arranged on a virtual interface panel, wherein the virtual interface panel is an electronic graphically displayable representation of an area, said method comprising the steps of:
providing a display panel displaying a portion of the virtual interface panel with the graphics objects corresponding to the displayed portion of the virtual interface panel, the virtual interface panel being larger than the displayed portion of the virtual interface panel;
defining a threshold region in a center of the display panel, wherein a first group of the graphics objects are associated with positions within the portion displayed on the display panel and outside of the threshold region;
displaying the graphics objects of the first group so that the positions of the graphics objects of the first group on the display panel are projected from a center of the display panel toward the edge and so that each of the graphic objects in the first group is displayed proximate the edge of the display panel; and
moving the display panel relative to the virtual interface panel so that the display panel displays another portion of the virtual interface panel.

7. The method of claim 6, wherein said step of displaying further comprises displaying a second group of graphics objects associated with positions within the display panel and within the threshold region in an unprojected manner so that the graphic objects of the second group are displayed at the associated positions on the display panel.

8. The method of claim 6, wherein a second group of graphics objects are associated with positions within the displayed portion and within the threshold region, said step of displaying comprising projecting the positions of the graphics objects of the second group away from the center of the display panel toward the edge of the display panel so that for each graphics object of the second group, the ratio of the distance between the center of the display panel and the associated position of the each graphics object and the distance between the center of the display panel and a boundary of the threshold region is the same as the ratio of the distance between the center of the display panel and a position of the projected position of the each graphics object and the distance between the center of the display panel and the edge of the display panel.

9. The method of claim 6, wherein the step of displaying comprises displaying, for each of the graphics objects in the first group, a reference line from the associated position of the each of the graphics objects of the first group to the displayed graphics object projected onto the edge of the display panel.

10. The method of claim 6, wherein the virtual interface panel comprises an electronic map.

11. A communication device, comprising:
a display having a display panel with a center and an edge; and
a processor device configured to display a portion of a virtual interface panel on said display, wherein the virtual interface panel comprises an electronic graphically displayable representation of an area, the virtual interface panel being larger than the displayed portion, said processor device being further configured for displaying graphics objects on said display panel, the graphics objects being associated with positions within the displayed portion, prescribing a threshold region centrally within said display panel, and displaying a first group of graphics objects associated with positions within the display portion and outside of the threshold region such that the positions of the graphics objects in said first group are projected from a center of the display panel toward the edge of the display panel and so that each of the graphics objects in the first group is displayed proximate the edge of said display panel.

12. The communication device of claim 11, wherein said virtual interface panel comprises an electronic map.
